(19) United States
(12) Patent Application Publication
(10) Pub. No.: US 2026/0342479 A1
(43) Pub. Date: Oct. 29, 2026

(54) SIGNALING PDU SETS WITH APPLICATION LAYER FORWARD ERROR CORRECTION IN A WIRELESS COMMUNICATION NETWORK

(71) Applicant: LENOVO (SINGAPORE) PTE. LTD., Singapore (SG)

(72) Inventors: Razvan-Andrei STOICA, Essen (DE); Joachim LOHR, Wiesbaden (DE); Dimitrios KARAMPATSIS, Ruislip (GB); Prateek BASU MALLICK, Dreieich (DE); Ravi KUCHIBHOTLA, Chicago, IL (US)

(21) Appl. No.: 19/110,762

(22) PCT Filed: Oct. 17, 2022
(86) PCT No.: PCT/EP2022/078790

§ 371 Date: Mar. 11, 2025

(30) Foreign Application Priority Data
Sep. 14, 2022 (GR) 20220100750

(51) Int. Cl. H04L 1/00; H04L 65/65; H04L 65/75; H04L 67/131

(52) U.S. Cl. CPC H04L 1/0083; H04L 1/0057; H04L 1/0075; H04L 65/65; H04L 65/75; H04L 67/131

(57) ABSTRACT

There is provided a method in a node of a wireless communication network. The method comprises receiving from an application a plurality of encoded protocol data units (PDUs) corresponding to an encoded application data unit (ADU), whereby the encoding is based on an Application-Layer Forward Error Correction (AL-FEC) coding configuration such that the encoded ADU comprises both a plurality of source PDUs and a plurality of repair PDUs, the encoded PDUs including metadata. The method further comprises identifying an Application-Layer Forward Error Correction (AL-FEC) coding configuration that was used to encode the encoded ADU. The method further comprises identifying, based on the metadata of the received PDUs, the plurality of source PDUs and the plurality of repair PDUs. The method further comprises defining a Protocol Data Unit Set (PDU set) containing both the plurality of source PDUs and the plurality of repair PDUs.

### FIELD

The subject matter disclosed herein relates generally to the field of implementing signaling PDU sets with application layer forward error correction. This document defines a method in a node of a wireless communication network, and a node in a wireless communications network.

### BACKGROUND

Herein, extended Reality (XR) is used as an umbrella term for different types of realities of which Virtual Reality, Augmented Reality, and Mixed Reality are examples. XR application traffic is subject to strict bandwidth and latency limitations in order to deliver an appropriate Quality of Service and Quality of Experience to an end user of an XR service. Such strict bandwidth and latency limitations can make delivery of XR application traffic over a wireless communication network challenging.

IETF defined to this point a generic forward error correction framework (FECFRAME) as IETF RFC 6363 which allows for various FEC Schemes to be applied for application-level FEC. FECFRAME specifies source packet and repair packet formats and FEC Scheme configuration procedures for AL-FEC both over transport layer (e.g., UDP), as well as over RTP layer or alike (e.g., WebRTC). AL-FEC traffic comprises both source PDUs and repair PDUs. If these are transmitted using different QoS flows, then the repair PDUs may not be present when needed at a receiving node.

### SUMMARY

In the context of XR media traffic, 3GPP SA2 Work Group recently introduced the concept of a ‘PDU set’ to group a series of PDUs carrying a unit of information at the application-level. Each PDU within a PDU set can thus be treated according to an identical set of QoS requirements and associated constraints of delay budget and error rate while providing support to a RAN for differentiated QoS handling at PDU set level. This improves the granularity of legacy 5G QoS flow framework allowing the RAN to optimize the mapping between QoS flow and DRBs to meet stringent XR media requirements (e.g., high-rate transmissions with short delay budget).

Disclosed herein are procedures for signaling PDU sets with application layer forward error correction. Said procedures may be implemented by a method in a node of a wireless communication network, and a node in a wireless communications network.

Accordingly, there is provided a method in a node of a wireless communication network. The method comprises receiving from an application a plurality of encoded protocol data units (PDUs) corresponding to an encoded application data unit (ADU), whereby the encoding is based on an Application-Layer Forward Error Correction (AL-FEC) coding configuration such that the encoded ADU comprises both a plurality of source PDUs and a plurality of repair PDUs, the encoded PDUs including metadata. The method further comprises identifying an Application-Layer Forward Error Correction (AL-FEC) coding configuration that was used to encode the encoded ADU. The method further comprises identifying, based on the metadata of the received PDUs, the plurality of source PDUs and the plurality of repair PDUs. The method further comprises defining a Protocol Data Unit Set (PDU set) containing both the plurality of source PDUs and the plurality of repair PDUs.

AL-FEC traffic comprises both source PDUs and repair PDUs. If these are transmitted using different QoS flows, then the repair PDUs may not be present when needed at a receiving node. The operation of the wireless communication network is thus improved by defining a PDU set that comprises both the plurality of source PDUs and the plurality of repair PDUs of the encoded ADU. The PDUs of a PDU set are treated according to a same set of QoS requirements and associated constraints of delay budget and error rate thus resulting in the plurality of source PDUs and the plurality of repair PDUs corresponding to the encoded ADU being delivered at an appropriate time.

There is further provided a node in a wireless communications network, the node comprising a receiver and a processor. The receiver is arranged to receive, from an application, a plurality of encoded protocol data units (PDUs) corresponding to an encoded application data unit (ADU), whereby the encoding is based on an Application-Layer Forward Error Correction (AL-FEC) coding configuration such that the encoded ADU comprises both a plurality of source PDUs and a plurality of repair PDUs, the encoded PDUs including metadata. The processor is arranged to identify an Application-Layer Forward Error Correction (AL-FEC) coding configuration that was used to encode the encoded ADU. The processor is further arranged to identify, based on the metadata of the received PDUs, the plurality of source PDUs and the plurality of repair PDUs. The processor is further arranged to define a Protocol Data Unit Set (PDU set) containing both the plurality of source PDUs and the plurality of repair PDUs.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for signaling PDU sets with application layer forward error correction in a wireless communication network will now be described, by way of example only, with reference to the accompanying drawings, in which:

FIG. 1 depicts an embodiment of a wireless communication system for signaling PDU sets with application layer forward error correction in a wireless communication network;

FIG. 2 depicts a user equipment apparatus that may be used for implementing the methods described herein;

FIG. 3 depicts further details of the network node that may be used for implementing the methods described herein;

FIG. 4 illustrates a method in a node of a wireless communication network;

FIG. 5 illustrates an overview of a core network architecture handling PDU sets for a content delivery example of XR media;

FIG. 6 provides an overview of the RTP and RTCP stack;

FIG. 7 illustrates an overview of the WebRTC stack;

FIG. 8 illustrates packet format and header information for both an RTP packet and an SRTP packet;

FIG. 9 is an illustration of an AL-FEC XR application flow including encoding, packetization and transport;

FIG. 10 shows an encoding process output of a source flow corresponding to the encoded source PDUs, and a repair flow corresponding to the encoded repair PDUs;

FIG. 11 illustrates an architecture and procedures for information exchange in support of AL-FEC encoded PDU set determination for DL and UL directions;

FIG. 12 illustrates the determination of an AL-FEC encoded PDU set comprised of a first subset of source PDUs and a second subset of repair PDUs;

FIG. 13 illustrates a 5GS GTP-U data plane protocol stack of a PDU session;

FIG. 14 illustrates the structure of the GTP-U header; and

FIG. 15 presents an example of a minimal size extension header of an AL-FEC encoded PDU set.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures.

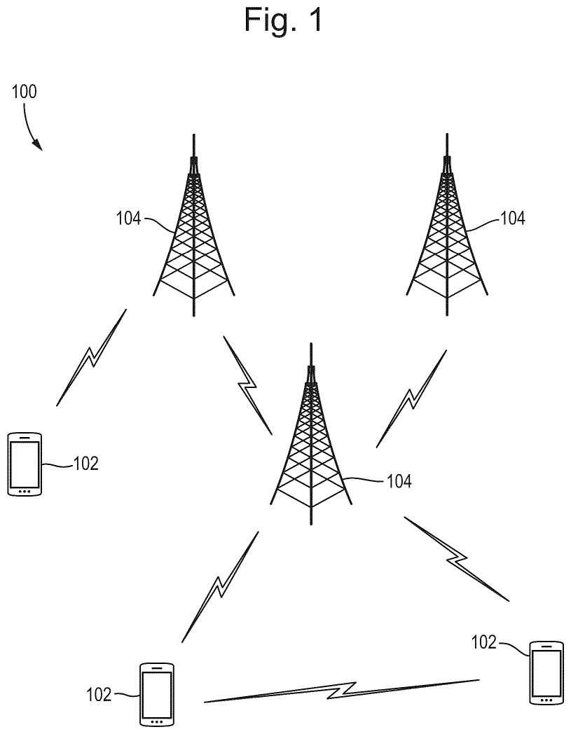

FIG. 1 depicts an embodiment of a wireless communication system 100 for signaling PDU sets with application layer forward error correction in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may comprise a user equipment apparatus 200, a sender 900, or a UE 535, 1135, 1310 as described herein. The base unit 104 may comprise a network node 300, or a UPF 540, 1140, 1340 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, among other protocols. The present disclosure is not intended to be limited to the implementation of any particular wireless communication system architecture or protocol. The network units 104 may serve a number of remote units 102 within a serving area, for example, a cell or a cell sector via a wireless communication link. The network units 104 transmit DL communication signals to serve the remote units 102 in the time, frequency, and/or spatial domain.

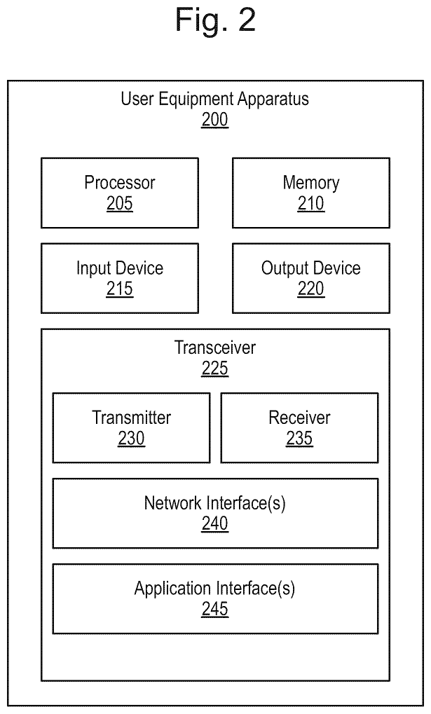

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, a sender 900, or a UE 535, 1135, 1310 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

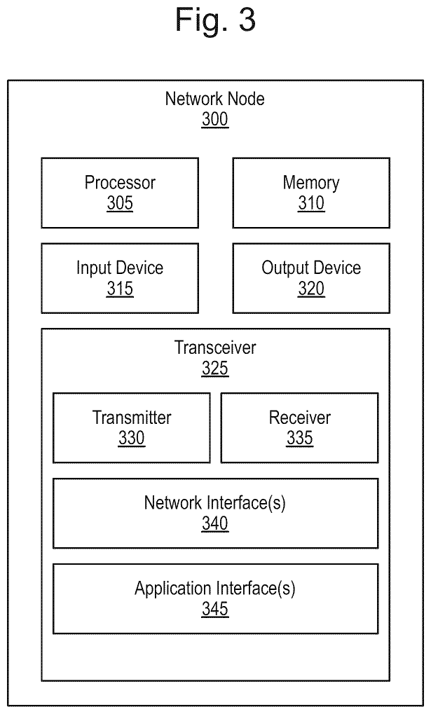

FIG. 3 depicts further details of the network node 300 that may be used for implementing the methods described herein. The network node 300 may comprise a base unit 104, or a UPF 540, 1140, 1340 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

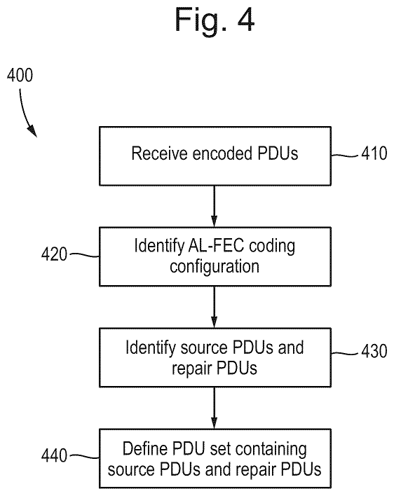

FIG. 4 illustrates a method 400 in a node of a wireless communication network. The method 400 comprises receiving 410 from an application a plurality of encoded protocol data units (PDUs) corresponding to an encoded application data unit (ADU), whereby the encoding is based on an Application-Layer Forward Error Correction (AL-FEC) coding configuration such that the encoded ADU comprises both a plurality of source PDUs and a plurality of repair PDUs, the encoded PDUs including metadata. The method 400 further comprises identifying 420 an Application-Layer Forward Error Correction (AL-FEC) coding configuration that was used to encode the encoded ADU. The method 400 further comprises identifying 430, based on the metadata of the received PDUs, the plurality of source PDUs and the plurality of repair PDUs. The method further comprises defining 440 a Protocol Data Unit Set (PDU set) containing both the plurality of source PDUs and the plurality of repair PDUs.

AL-FEC traffic may comprise both source PDUs and repair PDUs. If these are transmitted using different QoS flows, then the repair PDUs may not be present when needed at a receiving node. The operation of the wireless communication network is thus improved by defining a PDU set that comprises both the plurality of source PDUs and the plurality of repair PDUs of the encoded ADU. The PDUs of a PDU set are treated according to a same set of QoS requirements and associated constraints of delay budget and error rate thus resulting in the plurality of source PDUs and the plurality of repair PDUs corresponding to the encoded ADU being delivered at an appropriate time.

The PDU metadata may comprise RTP header fields or SRTP header fields. The node may comprise a user plane function (UPF) where the PDUs travel in a downlink direction. The node may comprise a user equipment (UE) where the PDUs travel in an uplink direction. The application may comprise an application server or an application client. The repair PDUs may be recovery PDUs.

The method may further comprise identifying the AL-FEC configuration based on at least one of: control plane information obtained from a network application function (AF) interfacing with the application; and data plane information obtained from an SDP session management signaling procedure of the application.

The control plane information obtained from a network application function (AF) interfacing with the application may comprise, for example, an application informing explicitly over the SMF the 5GS given AF indications to the PCF, and to the NEF/PFDF of the QoS requirements, traffic description, and AL-FEC encoding applied. The data plane information obtained from an SDP session management signaling procedure of the application may comprise, for example, session establishment and/or session update, whereby the SDP offer/answer procedure decides interactively the applied AL-FEC configuration based on a transmitter and on a received AL-FEC capabilities.

The source PDUs may comprise ADU information of an application, and wherein the repair PDUs are associated with the source PDUs and comprise repair encoded information for recovery of the ADU information of the application.

The method may further comprise transmitting the PDU set, and whereby transmission of the PDU set comprises interleaved transmission of source PDUs and repair PDUs.

The repair PDUs of the PDU set may be received within a timing window relative to their associated source PDUs of the PDU set. The timing window may comprise a repair-window as configured by the SDP offer/answer procedure.

The method may further comprise transmitting the PDU set to a radio access network with metadata information identifying at least one of: the source PDUs; the repair PDUs; and the AL-FEC coding configuration.

The metadata information identifying the source PDUs and the repair PDUs may comprise at least one of: an indication of the start of the PDU set; an indication of the start of the source PDUs in the PDU set; an indication of the end of the PDU set; an indication of the end of the repair PDUs in the PDU set; an indication of the end of the source PDUs in the PDU set; an indication of the start of the repair PDUs in the PDU set; an indication of the size of the PDU set; an indication of the size of a first part of the PDU comprising source PDUs; an indication of the size of a second part of the PDU set comprising repair PDUs; and an indication marking a source PDU type and a repair PDU type for each PDU of the PDU set.

The indication of the size of the PDU set or a part thereof may comprise an indication in a unit of bytes, words, or PDUs. The indication marking the type of PDU within the PDU set may comprise a bit field indicating a bit value, i.e., ‘0’, for a source PDU, and respectively, the reciprocal/negated bit value, i.e., ‘1’, for a repair PDU.

The metadata information identifying the AL-FEC coding configuration may comprise at least one of: an indication of the encoding rate; and an indication of a minimum number of PDUs of the PDU set necessary for the recovery of an ADU encoded by the PDU set.

The indication of the encoding rate may comprise a tabulated index representing a ratio of source PDUs to repair PDUs, a tabulated index representing a ratio of source symbols to total number of source and repair symbols, and/or a number of source PDUs and a number of total encoded PDUs within the PDU set. The indication of the minimum number of necessary PDUs from the PDU set for the recovery of the ADU information may refer to both source and repair PDUs. This indication may be represented as a tabulated bitfield of a percentage level of necessary PDUs out of the total PDUs of the encoded PDU set for the recovery of the ADU information.

The metadata information may be comprised within a GPRS Tunnelling Protocol for a User Plane (GTP-U) header field. The data plane signaling mechanism can comprise source PDUs indications, repair PDUs indications and AL-FEC indications.

The metadata information identifying the AL-FEC coding configuration may be signaled by the application to a network Policy Control Function (PCF). The indication of a minimum number of PDUs of the PDU set necessary for the recovery of ADU information may apply to a plurality of PDU sets. This indication may be considered as static information. Similarly, an indication of the encoding rate may apply to a plurality of PDU sets. That indication may also be considered as static information. The control plane signaling mechanism can comprise metadata information elements of AL-FEC static indications.

There is further provided a node in a wireless communications network, the node comprising a receiver and a processor. The receiver is arranged to receive, from an application, a plurality of encoded protocol data units (PDUs) corresponding to an encoded application data unit (ADU), whereby the encoding is based on an Application-Layer Forward Error Correction (AL-FEC) coding configuration such that the encoded ADU comprises both a plurality of source PDUs and a plurality of repair PDUs, the encoded PDUs including metadata. The processor is arranged to identify an Application-Layer Forward Error Correction (AL-FEC) coding configuration that was used to encode the encoded ADU. The processor is further arranged to identify, based on the metadata of the received PDUs, the plurality of source PDUs and the plurality of repair PDUs. The processor is further arranged to define a Protocol Data Unit Set (PDU set) containing both the plurality of source PDUs and the plurality of repair PDUs.

The processor may be further arranged to identify the AL-FEC configuration based on at least one of: control plane information obtained from a network application function (AF) interfacing with the application; and data plane information obtained from an SDP session management signaling procedure of the application.

The control plane information obtained from a network application function (AF) interfacing with the application may comprise, for example, an application informing explicitly over the SMF the 5GS given AF indications to the PCF, and to the NEF/PFDF of the QoS requirements, traffic description, and AL-FEC encoding applied. The data plane information obtained from an SDP session management signaling procedure of the application may comprise, for example, session establishment and/or session update, whereby the SDP offer/answer procedure decides interactively the applied AL-FEC configuration based on a transmitter and on a received AL-FEC capabilities.

The source PDUs may comprise ADU information of an application, and wherein the repair PDUs are associated with the source PDUs and comprise repair encoded information for recovery of the ADU information of the application.

The node may further comprise a transmitter arranged to transmit the PDU set. In a subset of these arrangements the transmission of the PDU set may comprise interleaved transmission of source PDUs and repair PDUs.

The repair PDUs of the PDU set may be received within a timing window relative to their associated source PDUs of the PDU set. The timing window may comprise a repair-window as configured by the SDP offer/answer procedure.

The node may further comprise transmitting the PDU set to a radio access network with metadata information identifying at least one of: the source PDUs; the repair PDUs; and the AL-FEC coding configuration.

The metadata information identifying the source PDUs and the repair PDUs may comprise at least one of: an indication of the start of the PDU set; an indication of the start of the source PDUs in the PDU set; an indication of the end of the PDU set; an indication of the end of the repair PDUs in the PDU set; an indication of the end of the source PDUs in the PDU set; an indication of the start of the repair PDUs in the PDU set; an indication of the size of the PDU set; an indication of the size of a first part of the PDU comprising source PDUs; an indication of the size of a second part of the PDU set comprising repair PDUs; and an indication marking a source PDU type and a repair PDU type for each PDU of the PDU set.

The indication of the size of the PDU set or a part thereof may comprise an indication in a unit of bytes, words, or PDUs. The indication marking the type of PDU within the PDU set may comprise a bit field indicating a bit value, i.e., ‘0’, for a source PDU, and respectively, the reciprocal/negated bit value, i.e., ‘1’, for a repair PDU.

The metadata information identifying the AL-FEC coding configuration may comprise at least one of: an indication of the encoding rate; and an indication of a minimum number of PDUs of the PDU set necessary for the recovery of an ADU encoded by the PDU set

The indication of the encoding rate may comprise a tabulated index representing a ratio of source PDUs to repair PDUs, a tabulated index representing a ratio of source symbols to total number of source and repair symbols, and/or a number of source PDUs and a number of total encoded PDUs within the PDU set. The indication of the minimum number of necessary PDUs from the PDU set for the recovery of the ADU information may refer to both source and repair PDUs. This indication may be represented as a tabulated bitfield of a percentage level of necessary PDUs out of the total PDUs of the encoded PDU set for the recovery of the ADU information.

The metadata information may be comprised within a GPRS Tunnelling Protocol for a User Plane (GTP-U) header field. The data plane signaling mechanism can comprise source PDUs indications, repair PDUs indications and AL-FEC indications.

The metadata information identifying the AL-FEC coding configuration may be signaled by the application to a network Policy Control Function (PCF). The indication of a minimum number of PDUs of the PDU set necessary for the recovery of ADU information may apply to a plurality of PDU sets. This indication may be considered as static information. Similarly, an indication of the encoding rate may apply to a plurality of PDU sets. That indication may also be considered as static information. The control plane signaling mechanism can comprise metadata information elements of AL-FEC static indications.

The study of XR Media (XRM) at the CN level in Release 18 of the 3GPP technical standards introduced the concept of a PDU set to handle QoS requirements of XRM applications and streams with a better granularity beyond QoS flow possibilities. As such, according to 3GPP Technical Report TR 23.700-60 (v0.0.3), a PDU set is composed of one or more PDUs carrying the payload of one unit of information generated at the application level (e.g. a frame or video slice for XRM Services). In some implementations all PDUs in a PDU set are needed by the application layer to use the corresponding unit of information. In other implementations, the application layer can still recover parts or all of the information unit, when some PDUs are missing.

In addition, the PDU set is associated with QoS requirements in terms of delay budget and error rate, which may be defined as PDU Set Delay Budget (PSDB), and/or as a PDU Set Error Rate (PSER). The PDU Set Delay Budget (PSDB) defines an upper bound for the time that a PDU set may be delayed between the UE and the N6 termination point at the UPF. PSDB applies to the DL PDU set received by the UPF over the N6 interface, and to the UL PDU set sent by the UE, respectively. The PDU Set Error Rate (PSER) defines an upper bound for the rate of PDU sets (e.g. set of IP packets constituting a PDU set) that have been processed by the sender of a link layer protocol (e.g. RLC in RAN of a 3GPP access) but where all of the PDUs in the PDU set are not successfully delivered by the corresponding receiver to the upper layer (e.g. PDCP in RAN of a 3GPP access). The PSER may be used to determine an upper bound for a rate of non-congestion-related packet losses.

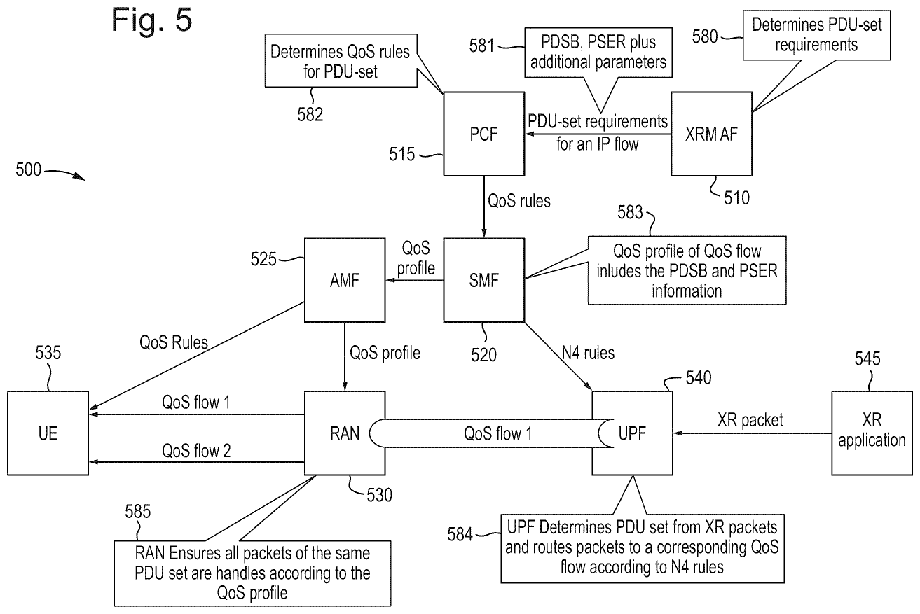

FIG. 5 illustrates an overview of a core network (CN) XRM architecture handling of PDU sets. FIG. 5 shows a system 500 comprising an Extended Reality Media Application Function (XRM AF) 510, a Policy and Control Function (PCF) 515, a Session Management Function (SMF) 520, an Access and Mobility Function (AMF) 525, a Radio Access Network (RAN) 530, a User Equipment (UE) 535, a User Plane Function (UPF) 540, and an Extended Reality Application 545. The UE 535 may comprise a remote unit 102, a user equipment apparatus 200, a sender 900, or a UE 1135, 1310 as described herein. The UPF 540 may comprise a base unit 104, a network node 300, or a UPF 1140, 1340 as described herein. The operation of system 500 will now be described in the example of downlink traffic, a similar process may operate for uplink traffic.

At 580, the XRM AF 510 determines PDU set requirements.

At 581, the XRM Application Function 510 provides QoS requirements for packets of a PDU set to the PCF 515 and information to identify the application (i.e. 5-tuple or application id). The QoS requirements may comprise PSDB and PSER. The XRM AF 510 may also include an importance parameter for a PDU set and information for the core network to identify packets belonging to a PDU set.

At 582, the PCF 515 derives QoS rules for the XR application and specific QoS requirements for the PDU set. The QoS rules may use a 5G QoS identifier (5QI) for XR media traffic. The PCF 515 sends the QoS rules to the SMF 520. The PCF 515 may include in the communication to the SMF 520 Policy and Charging Control (PCC) rules per importance of a PDU set. The PCC rules may be derived according to information received from the XRM AF 510 or based on an operator configuration.

At 583, the SMF 520 establishes a QoS flow according to the QoS rules by the PCF 515 and configures the UPF to route packets of the XR application to a QoS flow, and, in addition, to enable PDU set handling. The SMF 520 also provides the QoS profile containing PDU set QoS requirements to the RAN 530 via the AMF 525. The AMF 525 may provide the QoS profile containing PDU set QoS requirements to the RAN 530 in an N2 Session Management (SM) container. Further, the AMF 525 may provide the QoS rules to the UE 535 in an N1 SM container.

At 584, the UPF 540 inspects the packets and determines packets belonging to a PDU set. The packet inspection may comprise inspecting the RTP packets. When the UPF 540 detects packets of a PDU set the UPF 540 marks the packets belonging to a PDU set within a GTP-U header. The GTP-U header information includes a PDU set sequence number and the size of the PDU set. The UPF 540 may also determine the importance of the PDU set either based on UPF 540 implementation means, information provided by the XRM AF 510 or information provided as metadata from an XRM application server. Based on the importance of the PDU set the UPF 540 may route the traffic to a corresponding QoS flow 1 (according to the rules received from the SMF 520) or include the importance of the PDU set within a GTP-U header. QoS flow 1 may comprise GTP-U headers, and these may include PDU set information.

At 585, the RAN 530 identifies packets belonging to a PDU set (based on the GTP-U marking) and handles the packets of the PDU set according to the QoS requirements of the PDU set provided by the SMF 520. In one implementation the RAN 530 node may use a different radio bearer with higher QoS requirement (according to the PDU set PSDB/PSER) to guarantee delivery of the packets of the PDU set, while using a different radio bearer according to the 5QI of the QoS flow for the non-PDU set packets. RAN 530 may receive QFIs, QoS profile of QoS flow from SMF 520 (via AMF 525) during PDU session establishment/modification which includes PDSB and PSER. RAN 530 inspects GTP-U headers and ensures all packets of the same PDU set are handled according to the QoS profile. This may include packets of PDU set in a radio bearer carrying QoS flow 1. This may also include sending packets not belonging to the PDU set in a different radio bearer carrying QoS flow 2.

The above example relates to downlink (DL) traffic. Reciprocal processing is applicable to uplink (UL) traffic wherein the role of UPF 540 packet inspection is taken by the UE 535 which is expected to inspect uplink packets, determine packets belonging to a PDU set, and signal accordingly the PDU set to the RAN 530 for scheduling and resource allocation corresponding to an associated DRB capable of fulfilling the PDU set QoS requirements (i.e., PSDB and PSER). The low-level signaling mechanism associated with the UL UE-to-RAN information passing are up to the specification and implementations of RAN signaling procedures.

Herein, extended Reality (XR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary. Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, 3GPP SA4 Working Group analyzed the Media transport Protocol and XR traffic model in the Technical Report TR 26.926 (v1.1.0) titled “Traffic Models and Quality Evaluation Methods for Media and XR Services in 5G Systems”, and decided the QoS requirements in terms of delay budget, data rate and error rate necessary for a satisfactory experience at the application level. These led to 4 additional 5G QoS Identifiers (5QIs) for the 5GS XR QoS flows. These 5Qis are defined in 3GPP TS 23.501 (v17.5.0), Table 5.7.4-1, presented there as delay-critical GBR 5QIs valued 87-90. The latter are applicable to XR video streams and control metadata necessary to provide the immersive and interactive XR experiences.

The XR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.).

To support such stringent delay-critical requirements specific to real-time communications (RTC) with high bandwidth (e.g., XR video streams) the envisioned higher-layer protocols for delivery of XR immersive multimedia applications is the Real-time Transport Protocol (RTP). In this context reference may be made to 3GPP Technical Report TR 26.928 (v17.0.0) titled “Extended Reality (XR) in 5G”. In some implementations, secured RTP variants such as vanilla Secure Real-time Transport Protocol (SRTP) or web browser based WebRTC stacks may be used to serve XR applications across mobile communications networks such as 5GS and alike.

RTP is a media codec agnostic network protocol with application-layer framing used to deliver multimedia (e.g., audio, video etc.) in real-time over IP networks, as defined in IETF standard RFC 3550 titled “RTP: A Transport Protocol for Real-Time Applications”. It is used in conjunction with a sister protocol for control, RTP Control Protocol (RTCP) to provide end-to-end features such as jitter compensation, packet loss and out-of-order delivery detection, synchronization and source streams multiplexing.

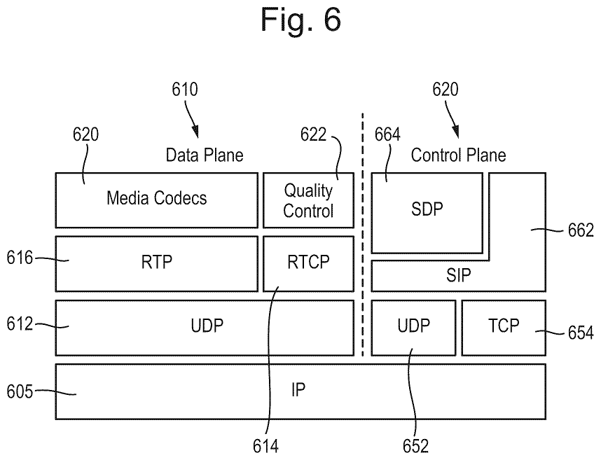

FIG. 6 provides an overview of the RTP and RTCP stack. An IP layer 605 carries signalling from the media session data plane 610 and from the media session control plane 650. The data plane 610 stack comprises functions for a User Datagram Protocol (UDP) 612, RTP 616, RTCP 614, Media codecs 620 and quality control 622. The control plane 650 stack comprises functions for UDP 652, Transmission Control Protocol (TCP) 654, Session Initiation Protocol (SIP) 662 and Session Description Protocol (SDP) 664.

SRTP is a secured version of RTP, and is defined by the IETF in RFC 3711 “The Secure Real-time Transport Protocol (SRTP)”. SRTP provides encryption (payload confidentiality), message authentication and integrity (header and payload signing), replay attack protection. Similarly, the SRTP sister protocol SRTCP provides the same functions to the RTCP counterpart. As such, in SRTP, the RTP header information is still accessible but non-modifiable, whereas the payload is encrypted. SRTP is used for this reason in the WebRTC stack which ensures secure RTC multimedia communications over web browser interfaces.

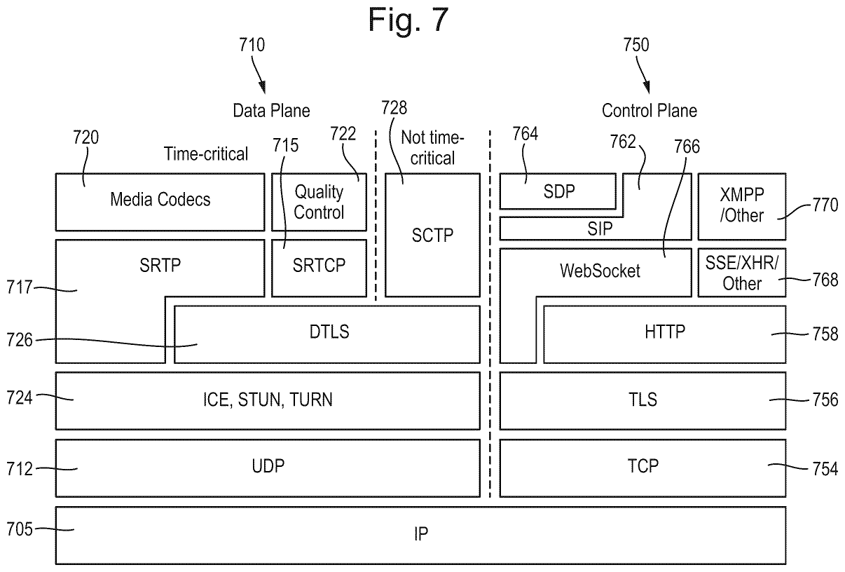

FIG. 7 illustrates an overview of the WebRTC stack. An IP layer 705 carries signalling from the data plane 710 and the control plane 750. The data plane 710 stack comprises functions for UDP 712, Interactive Connectivity Establishment (ICE) 724, Datagram Transport Layer Security (DTLS) 726, SRTP 717, SRTCP 715, media codes 720, Quality Control 722 and SCTP 728. ICE 724 may use the Session Traversal Utilities for NAT (STUN) protocol and Traversal Using Relays around NAT (TURN) to address real-time media content delivery across heterogeneous networks and NAT rules. SCTP 728 may be non time critical. SRTP 717, SRTCP 715, media codes 720, and Quality Control 722 may be time critical.

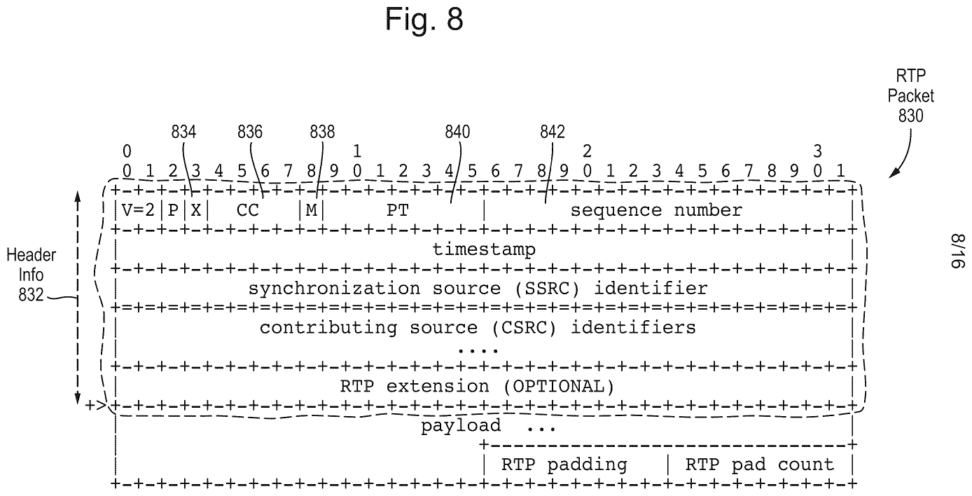

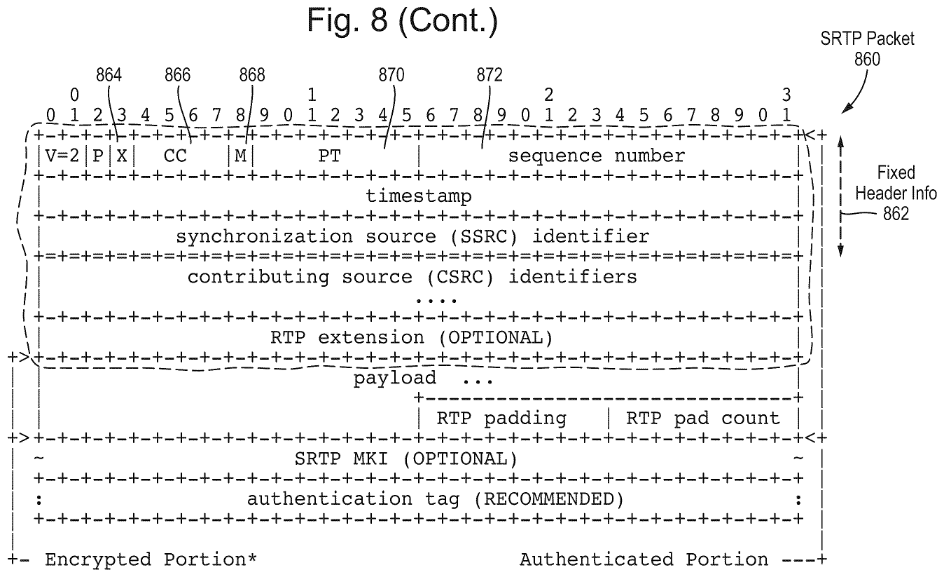

FIG. 8 illustrates packet format and header information for both an RTP packet 830 and an SRTP packet 860. The header information is available for inspection and processing and an overview is provided below including a brief description of certain fields of interest in the header portion of the RTP/SRTP packet formats

“X” 834, 864 is 1 bit indicating that the standard fixed RTP/SRTP header will be followed by an RTP header extension usually associated with a particular data/profile that will carry more information about the data (e.g., the frame marking RTP header extension for video data, as defined in RTP Frame Marking RTP Header Extension (November 2021)-draft-ietf-avtext-framemarking-13).

“CC” 836, 866 is 4 bits indicating number of contributing media sources (CSRC) that follow the header.

“M” 838, 868 is 1 bit intended to mark information frame boundaries in the packet stream, whose behaviour is exactly specified by RTP profiles (e.g., H.264, H.265, H.266, AV1 etc.)

“PT” 840, 870 is 7 bits indicating the payload type, which in case of video profiles is dynamic and negotiated by means of SDP (e.g., 96 for H.264, 97 for H.265, 98 for AV1 etc.).

“Sequence number” 842, 872 is 16 bits indicating the sequence number which increments by one with each RTP data packet sent over a session.

“Timestamp” 844, 874 is 32 bits indicating timestamp in ticks of the payload type clock reflecting the sampling instant of the first octet of the RTP data packet (associated for video stream with a video frame), whereas the first timestamp of the first RTP packet is selected at random.

“Synchronization Source (SSRC) identifier” 846, 876 is a 32 bit field indicating a random identifier for the source of a stream of RTP packets forming a part of the same timing and sequence number space, such that a receiver may group packets based on synchronization source for playback.

Hereafter we refer to a video frame as a video coded representation of a still image presented in a sequence composing a video stream. On the other hand, a video frame may be composed of one or more video slices. A video slice is a coded video representation of a partition of a still image part of a video sequence. In some implementations video slices may be referred to rectangular partitions (e.g., tiles) of the still image (e.g., H.266, AV1), whereby in other implementations video slices may be raster scan partitions of the still image (e.g., H.264, H.265, H.266 etc.). Similarly, we refer to a video layer as a video coding element either as a temporal video layer meant to increase the frames per second resolution and temporal level of details of a video sequence or as a spatial video layer meant to increase the number of video coded pixels and spatial resolution of individual video frames of a video sequence. The abstract concepts of video frame, video slice and/or video layers are applicable to MPEG family of modern hybrid video codecs (i.e., H.264/H.265/H.266), as well as, other open video codecs such as AV1 or VP9. The encapsulation format of video coded data to RTP/SRTP payloads is specified by Internet Standards for each individual video codec, e.g., H.264 by RFC 6184, H.265 by RFC 7798, AV1 by, for example, RTP Payload Format For AV1 (aomediacodec.github.io).

Note that for an XR application the media codecs used and their configuration/configuration updates depend on the application implementation and these are usually negotiated between a sender and a receiver upon session establishment/session update (e.g., RTP/SRTP). To this end, Session Description Protocol (SDP) signaling is used either as standalone signaling procedure or as part of the Session Initiation Protocol (SIP).

In various interactive XR applications involving multi-point communication (e.g., conference, shared classroom etc.) application-layer forward error correction (FEC) is used as a method to combat congestion and packet loss. This is possible also in point-to-point communication whereby the application-layer FEC may exploit link path diversity either at the network routing level or at the physical layer. By way of example, in 5GS link path diversity may be provided by dual connectivity (DC), carrier aggregation (CA) as well as multi-TRP transmissions. This applies for instance to 1D/2D parity check codes (e.g. as defined in IETF RFC 8627), Raptor codes (e.g., as defined in IETF RFC 5032), RaptorQ codes (e.g., as defined in IETF RFC 6330), and LDPC staircase codes (e.g., as defined in IETF RFC 6816).

IETF has defined a generic forward error correction framework (FECFRAME) as IETF RFC 6363 which allows for various FEC Schemes to be applied for application-level FEC. FECFRAME specifies source packet and repair packet formats and FEC Scheme configuration procedures for AL-FEC both over transport layer (e.g., UDP), as well as over RTP layer or alike (e.g., WebRTC).

The forward error correction framework, FECFRAME, operates consequently on application data units (ADU), e.g. RTP packets in case RTP is used for encapsulation of media information units.

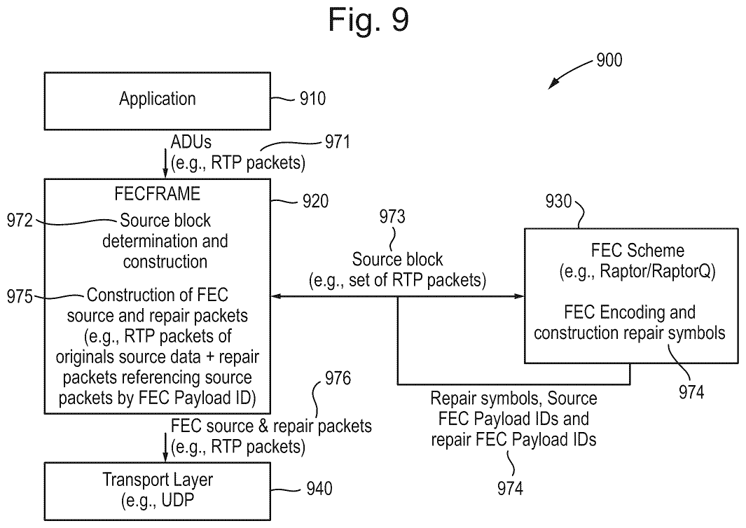

FIG. 9 is an illustration of an AL-FEC XR application flow including encoding, packetization and transport. This presents the role of FECFRAME and application of various FEC coding schemes. FIG. 9 shows a sender 900 comprising an application 910, a FECFRAME 920, a FEC scheme 930 and a transport layer 940. The sender 900 may comprise a remote unit 102, a user equipment apparatus 200, a UE 535, 1135, 1310, a base unit 104, a network node 300, or a UPF 540, 1140, 1340 as described herein.

In some embodiments, a popular AL-FEC coding scheme given its efficient encoding/decoding is Raptor coding (IETF RFC 5032), or alternatively, in other embodiments, its optimized version RaptorQ coding (IETF RFC 6330). Applied in the context of FECFRAME Raptor/RaptorQ encodes RTP packets as per IETF RFC 6881 and IETF RFC 6882. An example of some generic steps of this application flow are described as follows.

At 971, the application 910 in the sender 900 determines a set of source packets (e.g., RTP source packets) representing an ADU as a source block, to be protected jointly based on an AL-FEC coding configuration.

The AL-FEC coding configuration may comprise FECFRAME Configuration Information containing: a FEC Scheme identifier; a maximum source block length (MSBL) or alternatively K_max for Raptor/RaptorQ; an encoding symbol size (i.e., a T parameter for Raptor/RaptorQ coding schemes); and a repair-window duration (i.e., a maximum time in milliseconds and/or microseconds that spans the transmission of the source packets and the corresponding repair packets, whereby the transmission point is considered to be downstream interface ingesting encoded PDUs post-encoding)).

At 972, the sender arranges the source packets (e.g., the RTP source packets) into a set of same-sized source symbols (that may represent smaller partitions into source symbols of configured size of source packets data).

At 973 and 974, the sender applies FEC scheme 930 (e.g., Raptor/RaptorQ/2D parity codes) according to AL-FEC configuration (e.g., FECFRAME Configuration Information) to generate the required number of repair symbols.

At 975, the sender performs packetization of the repair symbols into repair packets (e.g., RTP repair packets according to IETF RFC 6882) and sends 976 the repair packets and the source packets via the transport layer 940 to a receiver.

Under FECFRAME requirements (i.e., IETF RFC 6363), the sender shall transmit the source and repair packets in different source and repair flows, e.g., RTP streams, to allow for legacy (non-FEC) applications processing of source packets similar to any systematic code.

The receiver receives source and repair packets. If all the source packets are successfully received, no FEC recovery is needed and the FEC repair packets can be discarded.

If there are however missing source packets the repair packets can be processed and used to recover the lost information within a latency corresponding to at least a repair-window time configured by the application FEC configuration.

Raptor/RaptorQ FEC Scheme recovery properties determine that recovery of K encoded source packets is possible from any K+h coded source or repair packets with a probability 1−1/256\hat{ }(h+1), whereby an encoded symbol corresponds to an encoded packet. This implies that recovering K encoded source symbols from a set of N encoded source and repair packets where only K+1 encoded packets have been received is guaranteed with essentially more than 99.99%, i.e., a very large probability. In other embodiments, whereby an encoded packet corresponds to more than one encoded symbol, a high probability of recovery is maintained also after packetization thus allowing Raptor/RaptorQ codes to achieve strong error correction performance.

In embodiments of FECFRAME for general flows, it is required that ADU source PDUs (e.g., the source RTP PDUs) contain an additional footer representing a Payload ID. This is used on the receiver side to determine if an encoded PDU is lost and to aid selection and usage of proper recovery slot for decoding missing packets based on the encoded available PDUs, i.e., either source or repair PDUs. In many embodiments where RTP/SRTP is used, this information is readily available as part of the RTP/SRTP sequence number which acts as a Payload ID replacement. In such embodiments the source RTP/SRTP packets resulting from a FECFRAME encoding are sent unchanged similarly to any systematic coding procedure. This provides backwards compatibility to receivers not supporting AL-FEC for example. In one embodiment the FEC encoding scheme used to encode the source and repair PDUs as RTP/SRTP packets is using therefore the sequence number of the original RTP/SRTP source packets as a Payload ID replacement (e.g., for Raptor/RaptorQ code, in Single Sequenced Flow encoding mode according to IETF RFC 6681). This indicates thus the dependency of encoded repair RTP/SRTP packets to the block of RTP/SRTP source packets jointly encoded aiding the decoder endpoint in efficient decoding.

To handle PDU sets for an XR QoS flow implies solving the problem of mapping traffic flow of an application to PDU sets. This corresponds to determining the PDU Set Boundaries (PSBs) (i.e., the start PSB and/or the end PSB of a PDU set).

This problem may be resolved either at the UPF for DL traffic or at the UE for UL traffic. The outcomes are subsequently used in DL as described in the prequel to setup, configure and map PDU sets to appropriate QoS rules by means of QoS flow. On the other hand, in UL the UE will use the determined PDU sets to map the PDU sets to particular DRBs which are subsequently mapped by the RAN over N3 to QoS flows by means of SDAP processing. The UPF shall then route the UL to an application server as per the PCF configured QoS rules and SMF setup QoS flow.

The PSBs determination considered by state-of-art is mainly performed by either or both of two approaches: Deep packet inspection, and RTP header information parsing. Deep packet inspection is however computational heavy with training and deployment requirements that make it infeasible for application in the UL direction for the UE processing.

Solutions that refer to using RTP packet format leverage a combination of one or more of the RTP timestamp, sequence number, payload type and M-bit marker to determine video frame boundaries. This information is complemented in some solutions by additional information extracted from application-specific and/or profile-specific RTP header extensions (e.g., draft-ietf-avtext-framemarking-13) or from parsing the RTP payload headers (e.g., of the video coded NAL units in H.26x codecs), as detailed in3GPP Technical Report TR 23.700-60 v0.0.3, titled “Study on XR (Extended Reality) and media services”.

However, these solutions do not consider AL-FEC traffic but refer only to non-encoded XR application traffic. Nonetheless, according to 3GPP SA4 Working Group (in particular 3GPP Liaison Statement from 3GPP SA4 WG to 3GPP SA2 WG, S4-220505 from SA4 Meeting #118e, 6th-12th April 2022), a PDU set may contain source and repair PDUs of an AL-FEC encoded source block, typical in multicast/broadcast as defined in 3GPP TS 26.246 v17.0.0 titled “Transparent end-to-end Packet-switched Streaming Service (PSS); 3GPP SMIL language profile”, or in conversational applications as described in 3GPP TS 26.114 v17.5.0 titled “IP Multimedia Subsystem (IMS); Multimedia telephony; Media handling and interaction”. This further motivates the determination of PDU sets for XR traffic encoded by an AL-FEC configuration and the associated encoded PDUs.

As an aside it is noted that 3GPP TR 23.700-60 (v0.0.3) titled “Study on XR (Extended Reality) and media services” describes using RTP packet format to leverage a combination of one or more of the RTP timestamp, sequence number and M-bit marker to determine video frame boundaries. This information is complemented in some solutions by additional information extracted from application-specific and/or profile-specific RTP header extensions (e.g., draft-ietf-avtext-framemarking-13) or from parsing the RTP payload headers (e.g., of the video coded NAL units in H.26x codecs). This last collected information is then used to extract some classification/estimation of the importance of the detected PDU set.

The solution presented herein uses the same strategy of using the RTP header to determine some information of the encoded PDUs, yet in contrast to the prior-art, the method uses an AL-FEC configuration and knowledge of the encoded application traffic to determine a PDU set further containing 2 subsets representing encoded source PDUs and encoded repair PDUs as a common PDU set. The co-dependent source PDU and repair PDU are thus grouped together as a PDU set.

The solution described herein is focused on the identification of an applied AL-FEC encoding configuration for the traffic flow of an application, which may be an XR application. The solution further describes determination of a mapping of an AL-FEC encoded ADU to a PDU set containing a subset of encoded source PDUs (i.e., original ADU data), and respectively, a subset of encoded repair PDUs (i.e., parity data obtained by redundantly combining source data for FEC recovery under prospective PDU losses during transmission). The solution may further comprise signaling of the determined information of the PDU set boundaries and its composition of a subset of encoded source PDUs and a subset of repair PDUs for downstream processing by lower layers.

The solution is generally focused on the user plane as it utilizes metadata information present in the media session management and media transport headers, such as SDP and RTP for instance. A packet filter is applied to extract such metadata information, store, and process it for a PDU session level corresponding to a media flow of a PDUs belonging to an XR application. The XR application is identifiable by means of a 5 tuple (e.g., (source IP, destination IP, source port, destination port, protocol)) or by means of an application identifier registered with the 5GS.

The identification of the applied AL-FEC encoding configuration is based in some embodiments therefore on an SDP offer/answer procedure tracking and processing by an UPF and/or UE packet filter. In other embodiments, an implicit signaling by the XR application informing the 5GS is applied. The implicit signaling utilizes an Application Function (AF) associated with the XR application and control plane procedures, e.g., Packet Flow Description (PFD) management, to communicate with a NEF and provision information about the AL-FEC encoding configuration of the encoded media flow. This enables the awareness of the UPF and/or UE packet filters of the AL-FEC encoding configuration.

The determination and mapping of the encoded media flow to PDU sets follows based on packet inspection at the UPF and/or UE based on packet filters. This may be done by processing metadata of RTP and/or SRTP media transport protocol. The determined encoded PDU set information is further relayed to a RAN entity by means of GPRS Tunneling Protocol for User Plane (GTP-U). The metadata is thus encapsulated in a GTP-U extension header. The metadata may comprise any of the start and/or stop of the encoded PDU set, the start and/or stop of encoded source PDU subset of the encoded PDU set, and/or the start and/or stop of the encoded repair PDU subset of the encoded PDU set.

The usage of AL-FEC for encoding XR application ADUs results in encoded source and repair PDUs. In one embodiment this may be obtained as an outcome of FECFRAME (i.e., IETF RFC 6363) processing given an AL-FEC configuration of at least:
a configured source block size,
an AL-FEC encoding scheme (e.g., Raptor/RaptorQ, 1D/2D flexible parity check, staircase LDPC encoding etc.),
a coding rate and/or redundancy level, and
an encoding symbol size.

The source block determines the maximum ADU data size that can be encoded at once. In some embodiments for ADUs smaller in size that the configured source block, the ADU data is supplemented with padding bits up to the size of the source block. In other embodiments for ADUs larger in size than the source block, an ADU is split in multiple partitions sized smaller or equal than the source block of the AL-FEC configuration.

In some embodiments the encoding symbol size is configured to match a Maximum Transmission Unit (MTU) corresponding to a PDU such that one encoding symbol is contained in one PDU, as either a source PDU or a repair PDU. In such embodiments padding is applied to source PDUs smaller in size than the encoding symbol size in both encoding and decoding to match the encoding symbol size. The padding bits are not transmitted as their value and/or number are known to both AL-FEC encoder and decoder given the AL-FEC configuration.

In other embodiments the encoding symbol size is configured to be smaller than an MTU of a PDU. In such embodiments one or more encoding symbols comprise a PDU, as either a source PDU or a repair PDU. In such embodiments padding is applied to source PDUs smaller in size than the smallest integer number of encoding symbols larger or equal in size than the source PDU. In both encoding and decoding to match the integer number of encoding symbols, padding is applied to the source PDU. The padding bits are not transmitted as their value and/or number are known to both AL-FEC encoder and decoder given the AL-FEC configuration.

The AL-FEC encoding and packetization generates for each encoded ADU a number of encoded source PDUs and a number of repair PDUs. In some embodiments, the number of encoded source PDUs is determined by the number of source PDUs representing the ADU input (e.g., number of RTP packets in the source block corresponding to an ADU), and the number of repair PDUs is determined by the AL-FEC encoding configuration, respectively by the AL-FEC coding rate and/or redundancy level. In an example, a number of K source PDUs is encoded to a number of K encoded source PDUs which are the same as the source PDUs, and respectively, a number of N−K>0 encoded repair PDUs corresponding to coding rate K/N<1, or equivalently, a redundancy level of (N−K)/K %.

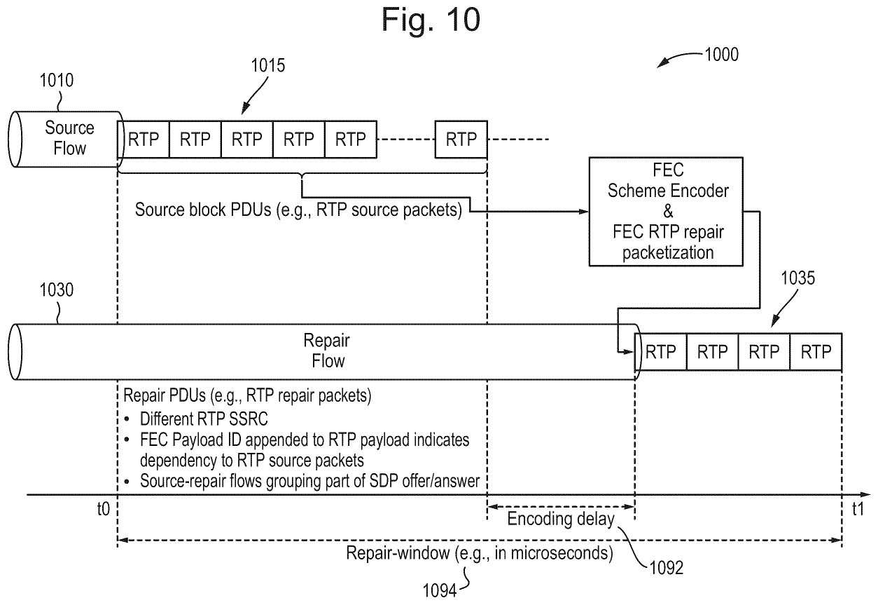

FIG. 10 shows an illustration of the encoding process 1000 of a source flow 1010 corresponding to the encoded source PDUs 1015, and a repair flow 1030 corresponding to the encoded repair PDUs 1035. The incoming RTP PDUs of the application are encoded and packetized by a systematic encoding. In such an embodiment, the source RTP PDUs remain unchanged post-encoding forming the systematic codeword of encoded source PDUs. In the same embodiment a block code comprising a FEC scheme encoder 1020 is used to encode the repair symbols up to the encoding symbols configured size and to packetize them in repair PDUs 1035 on the repair flow 1030. FIG. 10 also illustrates an encoding delay 1092 between the input encoded source PDUs 1015 and the corresponding encoded repair PDUs 1035. A repair window 1092 represents the time after an encoded source PDUs 1015 within which the corresponding encoded repair PDU 1035 might be used.

The source flow 1010 and repair flow 1030 may be transmitted over different RTP sessions, i.e., different source IP, source port addresses. In such embodiments, the co-dependent source and repair flows are associated at the media session level by a FEC grouping according to IETF RFC 5956 and IETF RFC 6364. Co-dependent source and repair flows are one or more flows such that the repair flows contain redundantly combined information of the source flows, depending on the latter. In similar fashion the source flows depend on the repair flows in case of errors, whereby redundant repair flows partial information can be used to recover the source flows information.

The FEC grouping is negotiated by the XR application during the SDP offer/answer procedure. In an example listing, the grouping of a source and repair flow within an SDP offer is determined as:
. . .
a=group: FEC-FR S1 R1
m=video 42420 RTP/AVP 100
c=IN IP4 233.252.0.1/127
a=rtpmap: 100 H264/90000
a=fec-source-flow: id=0
a=mid: S1
m=application 42420 UDP/FEC
c=IN IP4 233.252.0.2/127
a=fec-repair-flow: encoding-id=6; fssi=Kmax: 50,T:1280
a=repair-window: 15 ms
a=mid: R1
. . .

In the example above, the group (S1, R1) is created. The S1 flow represents the fec-source-flow identified by ID=0, and the R1 flow represents the fec-repair-flow described by its encoding scheme (i.e., encoding-id-6 corresponding to RaptorQ for single sequenced source flows as described in IETF RFC 6681) and parameters T=1280 bytes encoding symbols whereas a source block contains at maximum a length of K_max=50 symbols. The two co-dependent flows are thus grouped logically at the media session level, albeit being delivered over two different RTP sessions.

In other embodiments the same source and repair flows as above are transmitted by an RTP multiplexer over a common RTP session, whereby the different SSRCs of the two flows are multiplexed together as part of an ssrc-group as defined in IETF RFC 5956 at the SDP protocol level. In such an example, the source and repair flows from above would be described in an SDP offer/answer procedure as defined in IETF RFC 6682 as:
. . .
m=video 42420 RTP/AVP 100 110
c=IN IP4 233.252.0.1/127
a=rtpmap: 100 H264/90000
a=rtpmap: 110 raptorfec/90000
a=fmtp: 110 raptor-scheme-id=6; Kmax=50; T=1280; repair-window=15000
a=ssrc: 1000000
a=ssrc: 1000110
a=ssrc-group: FEC-FR 1000000 1000110
a=mid: FECGroup1
. . .

In the example above the source flow (SSRC=1000000 and payload type=100) and repair flow (SSRC=1000110 and payload type=110) are multiplexed over the same RTP session, yet the encoding parameters are the same as in the previous example.

In some embodiments, the AL-FEC encoded and co-dependent media flows are therefore determined by a 5GS by monitoring of SDP offer/answer procedure associated with an XR application where an offer endpoint initiates an SDP offer to an answer endpoint. The answer endpoint replies to the SDP offer with an SDP answer agreeing to a particular set of media streams, attributes, and parameters among which is also the AL-FEC configuration. The co-dependent grouping of source and repair flows is determined in one embodiment based on the “group” SDP attribute, whereas in another embodiment it is determined based on the “ssrc-group” SDP attribute whereby RTP SSRC multiplexing is applied.

In other embodiments, the AL-FEC encoding configuration may be signalled by the AF of the XR application to the NEF Packet Flow Description Function (PFDF) API as part of a set of one or more Packet Flow Description (PFD) objects identifying various AL-FEC configurations based on at least one of:
a 3-tuple including protocol, server-side IP and server-side port addresses;
a rule set of significant parts of an URL to be matched;
a rule set matching criterion of a domain name; and
an information enclosing protocol configuration (e.g., AL-FEC configuration such as coding rate, redundancy level, coding scheme, source block size, encoding symbol size, repair-window etc.).

In such an embodiment, the AF of the XR application will signal implicitly by control plane interfaces, e.g., NEF PFDF API, the AL-FEC configuration description to be applicable at the PDU session level for the encoded PDU traffic. The information thus signalled is managed according to the PFD management procedures by the SMF. The SMF informs the UPF of the PFD rules and the SMF informs the UPF also about the PCF determined PCC and QoS rules for the XR application traffic and AL-FEC associated coding configuration. The UPF can then apply the appropriate packet detection and filtering to determine the PDU sets containing the encoded co-dependent source PDUs as a subset and the repair PDUs as another subset.

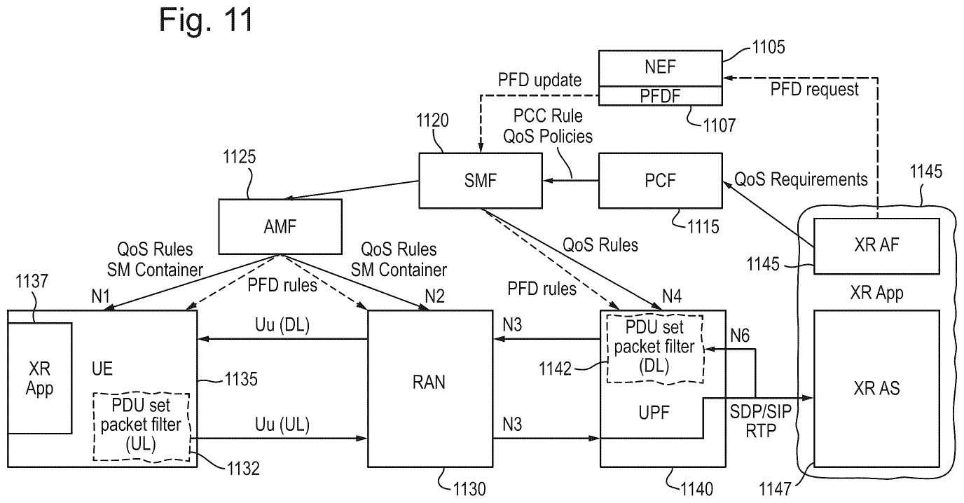

FIG. 11 illustrates an architecture and procedures for information exchange in support of AL-FEC encoded PDU set determination for DL and UL directions. FIG. 11 shows a system 1100 comprising an Extended Reality Media Application Function (XRM AF) 1110, that is part of an XR APP 1145. The XR APP 1145 includes an XR Application Service (AS) 1147. The system 1100 further comprises a Network Exposure Function (NEF) 1105 that includes a Packet Flow Description Function (PFDF) 1107. The system 1100 further comprises a Policy and Control Function (PCF) 1115, a Session Management Function (SMF) 1120, an Access and Mobility Function (AMF) 1125, a Radio Access Network (RAN) 1130, a User Equipment (UE) 1135, and a User Plane Function (UPF) 1140. The UE 1135 comprises a client XR Application 1137 and a PDU set packet filter 1132. The UPF 1140 comprises a PDU set packet filter 1142. The interfaces between certain components are additionally illustrated. The UE 1135 may comprise a remote unit 102, or a user equipment apparatus 200, a sender 900, or a UE 535, 1310 as described herein. The UPF 1140 may comprise a base unit 104, or a network node 300 or a UPF 540, 1340 as described herein.

Similarly, in another embodiment for UL transmissions the SMF can inform via the AMF the UE of the PFD rules and QoS rules for the XR application traffic.

The UE can then apply for UL transmissions an appropriate packet detection and filtering to determine PDU sets containing the encoded co-dependent source PDUs as a subset and repair PDUs as another subset.

In some embodiments the PDU set, the encoded source PDUs subset and the encoded repair PDUs subset are determined by the inspection of the RTP and/or SRTP fixed header information either at the UPF for DL transmissions or at the UE for UL transmissions. This contains at least the following RTP/SRTP header fields which can be used to determine the boundaries of an encoded ADU spanning the source PDUs subset and repair PDUs subset:
the M-bit marker field,
the payload type field,
the SSRC field,
the sequence number field, and
the timestamp field.

The M-bit marker field may indicate by a bit value of ‘1’ the end boundary of an ADU's information (i.e., video frame) identifying the end of source ADUs and thus of the encoded source PDUs subset.

Alternatively, the M-bit marker field may indicate by a bit value of ‘1’ the end of the repair PDUs associated with a source block corresponding to a source ADU and as such to an encoded source PDUs.

The payload type field may indicate the type of each payload carried by the RTP PDU as one of a source PDU media payload type (e.g., H264, HEVC etc.) or a repair PDU type (e.g., corresponding to a configured AL-FEC encoded flow). In an example of any of the SDP configurations earlier presented, the payload type of the source PDUs is ‘100’, whereas the payload type of the repair PDUs ‘110’.

The SSRC identifiers may further indicate the main synchronization source of each RTP PDU whereby source and repair PDUs may be multiplexed within the same stream and as such complement the payload type field in indicating the encoded source PDUs and repair PDUs. In the example for ‘ssrc-group’ SDP grouping configuration of co-dependent source and repair flows, the SSRC of the source PDUs is ‘1000000’, whereas the SSRC of the repair PDUs is ‘1000110’.

The sequence number field may label in sequence the PDUs and may provide a means for ordering the PDUs of a PDU set based on their original sampling thus enabling the logic separation of a first subset of PDUs as the source PDUs and a second subset of PDUs as the repair PDUs of the PDU set. In an embodiment the source and repair PDUs may be however interleaved given a specific AL-FEC encoding scheme configuration. In another embodiment the source and repair PDUs of a PDU set are not interleaved with the source PDUs subset being transmitted first followed by a second subset comprising the co-dependent repair PDUs.

The timestamp field may aid synchronization of PDUs and indicates within a PDU set the sampling timestamp of each PDU. In some embodiments the timestamp of source and repair PDUs is the same, whereas in other embodiments the timestamp of source PDUs is set to a timestamp ‘t0’ corresponding to the sampling of the source ADU (e.g., a video frame captured by a capturing input device and stored into memory), and the timestamp of repair PDUs is set to a timestamp ‘t1’ corresponding to timestamp ‘t0’ plus an encoding delay due to the AL-FEC encoding processing. The encoding delay is less or equal than the repair-window AL-FEC configuration. In an embodiment, the encoding delay and repair-window are determined by the XR application server based at least on a maximum end-to-end content delivery delay requirement and/or an end-to-end application delay requirement.

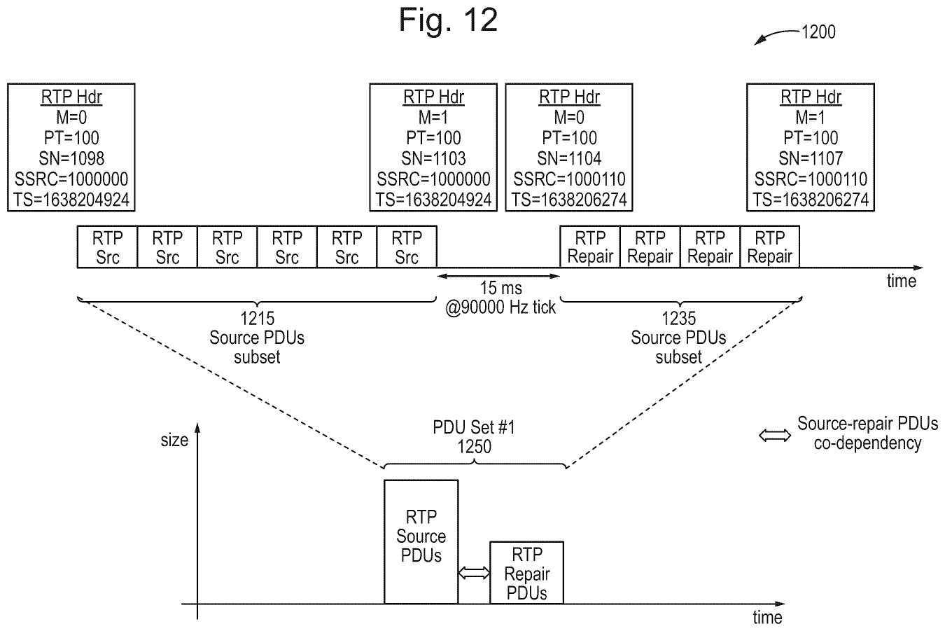

FIG. 12 illustrates the determination 1200 of an AL-FEC encoded PDU set 1250 comprised of a first subset of source PDUs 1215 and a second subset of repair PDUs 1235. The M-bit marker, payload type and/or SSRCs are used based on the SDP session information of the AL-FEC configuration to determine PDU sets. In addition, a first subset of the PDU set 1250 is determined comprising source PDUs 1215 and a second subset of the PDU set 1250 is determined comprising repair PDUs 1235, whereas the identification of the two is based on the payload type and/or SSRC RTP header field. It should be noted that the same processing may be performed with the same results for SRTP traffic.

To benefit of the determined AL-FEC encoded PDU set and encoded source PDUs subset and repair PDUs subset in downstream transmission and lower layer processing, the acquired PDU set information may be signaled to a RAN within a 5GS or alike. The backhaul transport within a 5GS is tunneling the PDU session traffic flows over an internal UDP/IP stack. The latter is performed by the GTP-U tunneling protocol enclosing an external IP network stack and relaying the PDU session to one or more RAN endpoints according to internal IP routing rules established for a PDU session over the control plane of a 5GS.

The GTP-U tunnel mechanism carries user data traffic over UDP transport over N3 and N9 interfaces. GTP-U tunnels between two corresponding GTP-U nodes separate traffic into different communication flows. A local Tunnel Endpoint Identifier (TEID), the IP address, and the UDP port uniquely identify a tunnel endpoint in each node, where the TEID assigned by the receiving entity is used for the communication. In an example of the 5GS CN GTP-U tunnels are established by providing the TEIDs and IP addresses between RAN and SMF. This is signaling over HTTP/2 between SMF and AMF and by Next Generation Application Protocol (NGAP) between AMF and RAN.

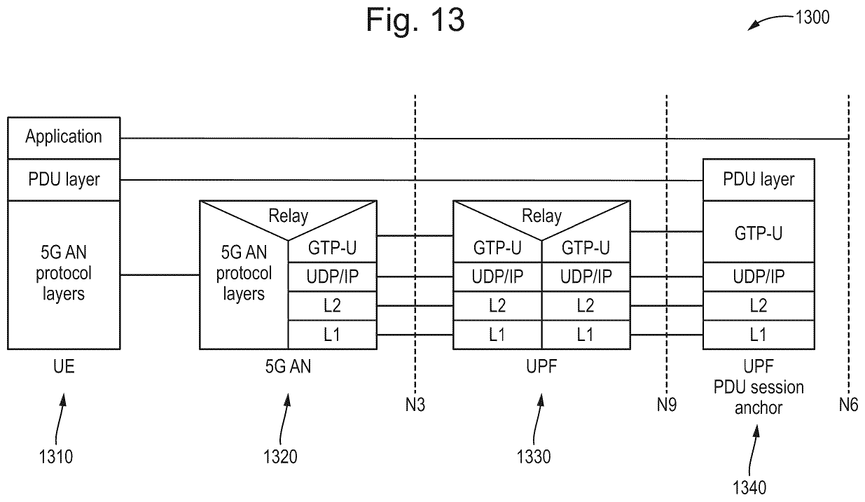

FIG. 13 illustrates a 5GS GTP-U data plane protocol stack of a PDU session 1300. The system comprises a UE 1310, a 5G AN 1320, a UPF 1330 and a UPF 1340. The UE 1310 may comprise a remote unit 102, a user equipment apparatus 200, a sender 900, or a UE 535, 1135 as described herein. The UPF 1340 may comprise a base unit 104, a network node 300, or a UPF 540, 1140 as described herein. The GTP-U header is a 4 byte-aligned structure formed in some embodiments of at least 8 bytes followed by at least 4 additional bytes depending on the content of the mandatory first 8 bytes. The GTP-U header can have in one embodiment one or more 4 byte-aligned extension headers which are chained together as a list by a prefixed next extension header type octet.

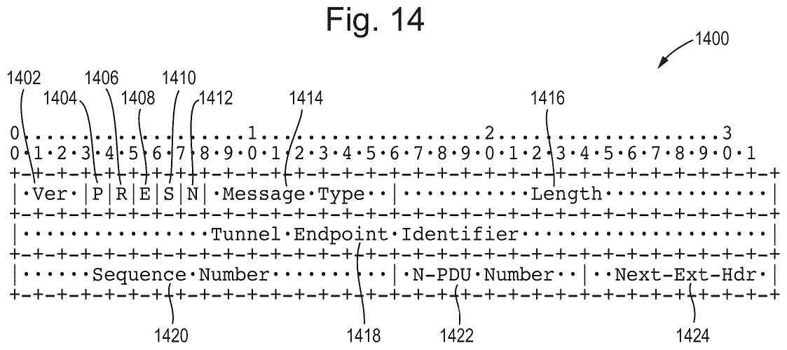

FIG. 14 illustrates the structure of the GTP-U header 1400. The GTP-U header comprises comprising: a version field (Ver) 1402 of 3 bits; a protocol type field (P) 1404 of 1 bit indicating a ‘1’ value for GTP-U; a reserved bit field (R) 1406 valued ‘0’; an extension header flag (E) 1408 bit field indicating the presence of an optional extension header field; a sequence number flag(S) 1410 bit field indicating the presence of an optional sequence number field; a N-PDU number flag (N) 1412 bit field indicating the presence of an optional N-PDU number field; a message type octet field 1414 indicating the type of GTP-U message (e.g., ‘255’ for G-PDU indicating a transport PDU); an octet field 1416 indicating the length of the payload in bytes; a 32 bits TEID 1418; an optional (increasing) sequence number octet field 1420 present if any of E, S, or N are toggled, yet to be processed only if S is toggled; an optional N-PDU number octet field 1422 present if any of E, S, or N are toggled, yet to be processed only if N is toggled; and an optional next extension header type octet field 1424 present if any of E, S, or N are toggled, yet to be processed only if E is toggled.

In some embodiments the information of the AL-FEC encoded PDU set is conveyed to/from the RAN by means of a GTP-U extension header. In an embodiment such an extension header includes information of at least one of:
an indication of the boundaries of a PDU set (e.g., a start and/or stop indication bit field, and/or a PDU set sequence number or identifier field),
an indication of the boundaries of a source PDU subset of the PDU set (e.g., a start and/or stop indication bit field corresponding to the source PDU subset)
an indication of the boundaries of a repair PDU subset of the PDU set (e.g., a start and/or stop indication bit field corresponding to the repair PDU subset)
an indication of the size of the PDU set size (e.g., as the number of all encoded PDUs forming the PDU set)
an indication of the size of the source PDUs subset of the PDU set (e.g., as the number of the source PDUs forming the source PDU subset)
an indication of the size of the repair PDUs subset of the PDU set (e.g., as the number of the repair PDUs forming the repair PDU subset)
an indication of the encoding rate of the AL-FEC configuration (e.g., as a bit field containing a tabulated index indicating a coding rate with a given granularity between a minimum coding rate, e.g., 0.25, and 1, i.e., uncoded, whereby the selected granularity occupies-log 2 (1/granularity) bits, or alternatively, a number of source PDUs and a number of total encoded PDUs within the PDU set)
an indication of a minimum number of PDUs (i.e., either source or repair PDUs) of the encoded PDU set that need to be successfully transmitted to a receiver for the receiver to be able to apply the AL-FEC coding configuration in decoding and recovering successfully the ADU encoded information.

In some embodiments the indication of the minimum number of necessary PDUs for ADU recovery is signaled as a percentage of the number of total PDUs in the encoded PDU set that need to be transmitted. In an example, the minimum number of necessary PDUs, i.e., m, for ADU recovery of an encoded PDU set is signaled as the quantized percentage value q′ that solves the problem:

$${q}^{′} = arg {min}_{q ∈ Q} ( q - \frac{m}{N} \geq 0 ) ,$$

where N denotes the number of total PDUs within the encoded PDU set and Q denotes the set of quantized percentage levels, e.g., Q={10, 20, 30, 40, 45, 50, 55, 60, 65, 70, 75, 80, 85, 90, 95, 100}. In this example any percentage level of Q is quantizable by 4 bits. The original m value signaled by q′ can be recovered thus by the reverse mapping:

$$m = ⌊ \frac{{q}^{′ \cdot } N}{100} ⌋ .$$

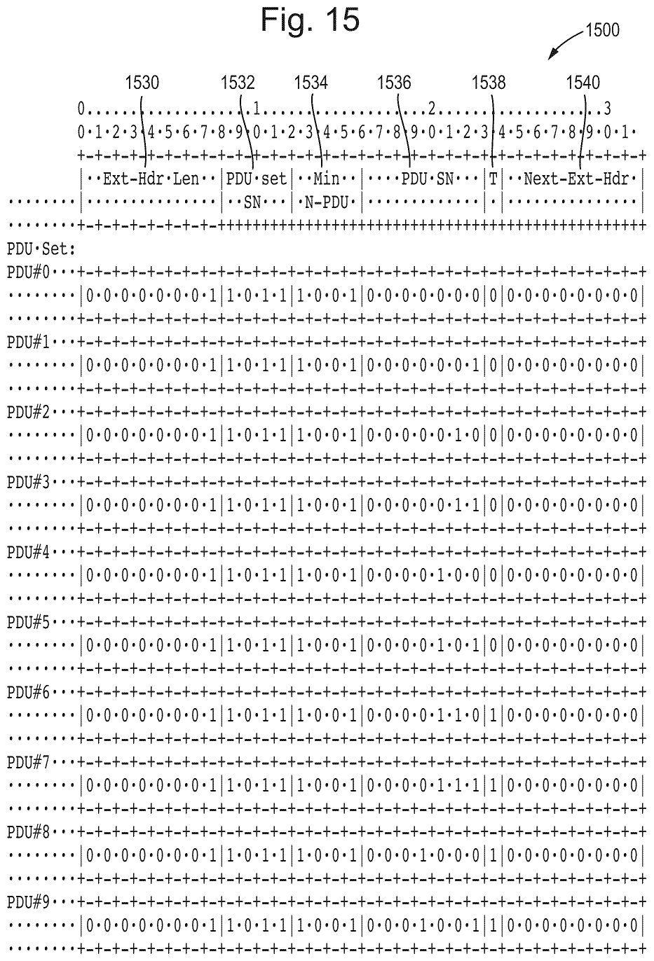

FIG. 15 presents an example of a minimal (i.e., least number of bytes possible) extension header 1500 of an AL-FEC encoded PDU set. The example extension header 1500 comprises: an octet (Ext Hdr Len, 1530) indicating the length of the extension header in units of 4 bytes; a nibble containing a PDU set sequence number (PDU set SN, 1532) increasing for each PDU set as a PDU set identifier module 2\hat{ }4; another nibble signaling the minimum number of necessary PDUs (Min N-PDU, 1534) for PDU set information recovery given the AL-FEC coding configuration and example signaling described above wherein q=10% is represented as ‘0000’ and q=100% is represented as ‘1111’ with the values in between represented monotonically increasing; a 7-bit field PDU sequence number (PDU SN, 1536) for each of the PDUs within the PDU set; a 1-bit field indicating the type (T, 1538) of each of the PDU, e.g., a ‘0’ value for a source PDU and ‘1’ value for a repair PDU; and a last byte (Next Ext Hdr, 1540) that signals that no other extension headers follow. In this case, the encoding rate of the AL-FEC of the PDU set is implicit given the PDU type marker and PDU SN within the PDU set, whereas the indication of the minimum number of necessary PDUs for the recovery of the encoded PDU set information is explicitly signaled. In the example of FIG. 15, a PDU set formed of 10 PDUs with 6 source PDUs and 4 repair PDUs is represented by means of the GTP-U extension headers of each PDU as previously described. The minimum number of necessary PDUs to recover the PDU set information with more than 99.99% certainty is thus m=7 given an AL-FEC coding configuration of a RaptorQ code with encoding-id=6 (i.e., corresponding to RaptorQ for single sequenced source RTP flows), T=1280 bytes encoding symbols, and a source block of maximum length of K_max=50 symbols. This maps to q′=70, represented as ‘1001’ as a nibble.

In some embodiments, the AL-FEC coding configuration information associated with a plurality of PDU sets is signaled over a control plane mechanism for downstream processing, e.g., by one or more RAN endpoints. In one embodiment, the AL-FEC coding configuration information contains, in part: an encoding scheme; an encoding rate; and/or a minimum percentage of PDUs (i.e., either source of repair PDUs) out of the encoded PDU set necessary to guarantee recovery of the ADU information given a set of QoS rules.

The AL-FEC coding configuration information is indicated by the SMF to the RAN over the AMF N2 interface. In another embodiment, the same information is signaled to the UE by the SMF over the AMF N1 interface for AL-FEC encoded PDU set traffic pertaining to UL. In an example, an application indicates via its AF the NEF and PCF with a corresponding set of PFD traffic descriptors and QoS requirements associated with an AL-FEC configuration used to encode application ADUs to PDU sets. The PCF generates PCC rules and configures the SMF with a corresponding set of QoS rules including an indication of a minimum percentage of PDUs (i.e., either source or repair PDUs) out of an encoded PDU set corresponding to the AL-FEC configuration that require transmission given the QoS requirements of the application.

Consider one example of an application with QoS requirements of an ADU error rate/PSER of 1e-2 that uses an AL-FEC RaptorQ systematic coding scheme (e.g., encoding-scheme-id=6 according to IETF RFC 6681) to encode ADUs to PDU sets with a configured redundancy level R % def (N−K)/K for any K source PDUs of a source block. This requires at least K+1 PDUs to recover the ADU information with at least 99.99% corresponding to the QoS requirements, and as such, a defined QoS rule indicating that a percentage of at least:

$$\frac{K + 1}{N} = \frac{1}{1 + \frac{R \%}{100}} + \frac{1}{N}$$

PDUs out of any N PDUs of an encoded PDU set satisfies the PSER QoS requirements of the application.

There is disclosed herein a method for mapping AL-FEC encoded XR traffic to a common PDU set based on data plane encoded PDU processing, whereby the determined PDU set is delimited by a first subset of source PDUs and a second subset of repair PDUs. There is also disclosed herein signaling mechanisms to convey said mapping relevant information to RAN via GTP-U headers.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards and application types, these examples are not intended to be the limit of the communications standards or application types to which the disclosed method and apparatus may be applied. For example, while specific examples have been given in the context of 3GPP, the principles disclosed herein can also be applied to another wireless communications system, and indeed any communications system which uses routing rules. Indeed, the methods and apparatus described herein are not only applicable to XR applications but can be used for any AL-FEC encoded application served over RTP or alike and that use PDU sets.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3rd generation partnership project; 5QI, 5G QoS Identifier; 5GS, 5G System; AMF, access and mobility function; ADU, application data unit; AF, application function; AR, augmented reality; DL, downlink; XR, extended reality; 5G, fifth generation; FEC, forward error correction; AL-FEC, application-layer forward error correction; FECFRAME, forward error correction framework; NAL, network abstraction layer; PPS, picture parameter set; PCF, policy control function; PDU, protocol data unit; QoE, quality of experience; QoS, quality of service; RAN, radio access network; RTCP, real-time control protocol; RTP, real-time protocol; SRTCP, secure real-time control protocol; SRTP, secure real-time protocol; SDAP, service data adaptation protocol; SMF, session management function; UL, uplink; UE, user equipment; UPF, user plane function; VCL, video coding layer; VMAF, video multi-method assessment function; VPS, video parameter set; VR, virtual reality; XR AS, XR application server; and XRM, XR media.

1. A method performed by a node of a wireless communication network, the method comprising:
receiving from an application a plurality of encoded protocol data units (PDUs) corresponding to an encoded application data unit (ADU),
wherein encoding is based on an Application-Layer Forward Error Correction (AL-FEC) coding configuration,
wherein the encoded ADU comprises both a plurality of source PDUs and a plurality of repair PDUs, and
wherein the encoded PDUs including metadata;
identifying an Application-Layer Forward Error Correction (AL-FEC) coding configuration that was used to encode the encoded ADU;
identifying, based on the metadata of the received PDUs, the plurality of source PDUs and the plurality of repair PDUs; and
defining a Protocol Data Unit Set (PDU set) containing both the plurality of source PDUs and the plurality of repair PDUs.

2. The method of claim 1, further comprising identifying the AL-FEC configuration based on at least one of:
control plane information obtained from a network application function (AF) interfacing with the application; and
data plane information obtained from an SDP session management signaling procedure of the application.

3. The method of claim 1, wherein the source PDUs comprise ADU information of an application, and wherein the repair PDUs are associated with the source PDUs and comprise repair encoded information for recovery of the ADU information of the application.

4. The method of claim 1, further comprising transmitting the PDU set, wherein transmission of the PDU set comprises interleaved transmission of source PDUs and repair PDUs.

5. The method of claim 1, wherein the repair PDUs of the PDU set are received within a timing window relative to their associated source PDUs of the PDU set.

6. The method of claim 1, further comprising transmitting the PDU set to a radio access network with metadata information identifying at least one of: the source PDUs, the repair PDUs, and the AL-FEC coding configuration.

7. The method of claim 6, wherein the metadata information identifying the source PDUs and the repair PDUs comprises at least one of:
an indication of a start of the PDU set;
an indication of a start of the source PDUs in the PDU set;
an indication of an end of the PDU set;
an indication of an end of the repair PDUs in the PDU set;
an indication of an end of the source PDUs in the PDU set;
an indication of a start of the repair PDUs in the PDU set;
an indication of a size of the PDU set;
an indication of a size of a first part of the PDU comprising source PDUs;
an indication of a size of a second part of the PDU set comprising repair PDUs; and
an indication marking a source PDU type and a repair PDU type for each PDU of the PDU set.

8. The method of claim 6, wherein the metadata information identifying the AL-FEC coding configuration comprises at least one of:
an indication of an encoding rate; and
an indication of a minimum number of PDUs of the PDU set necessary for the recovery of an ADU encoded by the PDU set.

9. The method of claim 6, wherein the metadata information is contained within a GPRS Tunnelling Protocol for a User Plane (GTP-U) header field.

10. The method of claim 6, wherein the metadata information identifying the AL-FEC coding configuration is signaled by the application to a network Policy Control Function (PCF).

11. A node in a wireless communications network, the node comprising:
at least one memory; and
at least one processor coupled with the at least one memory and configured to cause the node to:
receive, from an application, a plurality of encoded protocol data units (PDUs) corresponding to an encoded application data unit (ADU),
wherein the encoding is based on an Application-Layer Forward Error Correction (AL-FEC) coding configuration,
wherein the encoded ADU comprises both a plurality of source PDUs and a plurality of repair PDUs, and
wherein the encoded PDUs including metadata;
identify an Application-Layer Forward Error Correction (AL-FEC) coding configuration that was used to encode the encoded ADU;
identify, based on the metadata of the received PDUs, the plurality of source PDUs and the plurality of repair PDUs; and
define a Protocol Data Unit Set (PDU set) containing both the plurality of source PDUs and the plurality of repair PDUs.

12. The node of claim 11, wherein the at least one processor is further configured to cause the node to identify the AL-FEC configuration based on at least one of:
control plane information obtained from a network application function (AF) interfacing with the application; and
data plane information obtained from an SDP session management signaling procedure of the application.

13. The node of claim 11, wherein the source PDUs comprise ADU information of an application, and wherein the repair PDUs are associated with the source PDUs and comprise repair encoded information for recovery of the ADU information of the application.

14. The node of claim 11, wherein the at least one processor is further configured to cause the node to transmit the PDU set, wherein transmission of the PDU set comprises interleaved transmission of source PDUs and repair PDUs.

15. The node of claim 11, wherein the repair PDUs of the PDU set are received within a timing window relative to their associated source PDUs of the PDU set.

16. The node of claim 11, wherein the at least one processor is further configured to cause the node to transmit the PDU set to a radio access network with metadata information identifying at least one of: the source PDUs; the repair PDUs; and the AL-FEC coding configuration.

17. The node of claim 16, wherein the metadata information identifying the source PDUs and the repair PDUs comprises at least one of:
an indication of a start of the PDU set;
an indication of a start of the source PDUs in the PDU set;
an indication of an end of the PDU set;
an indication of an end of the repair PDUs in the PDU set;
an indication of an end of the source PDUs in the PDU set;
an indication of a start of the repair PDUs in the PDU set;
an indication of a size of the PDU set;
an indication of a size of a first part of the PDU comprising source PDUs;
an indication of a size of a second part of the PDU set comprising repair PDUs; and
an indication marking a source PDU type and a repair PDU type for each PDU of the PDU set.

18. The node of claim 16, wherein the metadata information identifying the AL-FEC coding configuration comprises at least one of:
an indication of an encoding rate; and
an indication of a minimum number of PDUs of the PDU set necessary for the recovery of an ADU encoded by the PDU set.

19. The node of claim 16, wherein the metadata information is contained within a GPRS Tunnelling Protocol for a User Plane (GTP-U) header field.

20. (canceled)

21. A user equipment (UE) for wireless communications network, the UE comprising:
at least one memory; and
at least one processor coupled with the at least one memory and configured to cause the UE to:
receive, from an application, a plurality of encoded protocol data units (PDUs) corresponding to an encoded application data unit (ADU),
wherein the encoding is based on an Application-Layer Forward Error Correction (AL-FEC) coding configuration,
wherein the encoded ADU comprises both a plurality of source PDUs and a plurality of repair PDUs, and
wherein the encoded PDUs including metadata;
identify an Application-Layer Forward Error Correction (AL-FEC) coding configuration that was used to encode the encoded ADU;
identify, based on the metadata of the received PDUs, the plurality of source PDUs and the plurality of repair PDUs; and
determine a Protocol Data Unit Set (PDU set) containing both the plurality of source PDUs and the plurality of repair PDUs.
